(19) United States
(12) Patent Application Publication
(10) Pub. No.: US 2002/0108361 A1
(43) Pub. Date: Aug. 15, 2002

(54) Energy storage cell

(76) Inventor: Kenneth Lawrence Kihlman, Glendale, AZ (US)

Correspondence Address: KEN KIHLMAN, 6212 W. PONTIAC DR, GLENDALE, AZ, 85308, US

(21) Appl. No.: 09/779,571

(22) Filed: Feb. 9, 2001

(51) Int. Cl. A01D 69/00

(52) U.S. Cl. 56/11.9

(57) ABSTRACT

Bands of rubber are geared in series to form a cell. The number of band of rubber and the size of the bands (length and width) will vary depending on power and duration needed. A controllable speed governor controls the RPM output of the energy storage cell. The output of the cell can be geared to match the power needed. The cell uses a disc type brake that is normally on and needs mechanical or hydraulic pressure to release it. The cell is charged with a high speed, auto shut off, worm drive motor. This type of drive stops the motor assembly from being turned backwards from the winding motor output gear. This stops the energy cell from unwinding when the charging motor has stopped. In the absence of electrical power the cell can be manually charged with an operator-powered crank connected to a power transfer gearbox.

### BACKGROUND OF THE INVENTION

1. Field of the Invention

This invention relates in general to a rechargeable power source and in particular to powering items used everyday. Examples: lawn mowers, weed eaters, golf carts, cars, and scooters, almost anything that would use an internal combustion engine or battery operated motor.

2. Prior Art

People have not succeeded in perfecting a power storage device that can safely store a large amount of energy in a compact and lightweight package. In the past the most commonly used energy storage device has been the lead acid battery. No device is known, however, for storing large amounts of energy that is lightweight, non-polluting, easily repairable, and quickly recharged.

### SUMMARY OF THE INVENTION

The principal object of the present invention is to provide a device that can power hundreds of different items without causing pollution.

It also is an object of the present invention to provide such a device that is made of simple inexpensive construction.

Another object of the present invention is to provide such a device that can be disassembled and repaired quickly.

A further object is to provide such a device, which can be charged from normal household current.

It also is an object of the present invention to provide such a device which can be charged very quickly.

A further object is to provide such a device, which can automatically shut off the high speed charging motor at a full charge.

Another object is to provide a device that, in the absence of electrical power, can be manually charged.

It also is an object of the present invention to provide such a device that can be built in many power and size configurations.

Another object of the present invention is to provide a device that is economical to operate.

The foregoing object can be accomplished by providing an energy cell with one up to hundreds of power modules. The power modules are connected in series with each other. Example: If your modules use 12″ long by 2″ wide bands of rubber and you have a hundred modules, this would be equal to having a hundred foot long band of rubber. The energy cell output is controlled by a centrifugal governor assembly. The governor is controlled by the variable slide assembly. There is also a brake assembly. This brake assembly is similar to a automotive disc brake. The difference being our brake is normally in the on position. In order to release the brake you must overcome a spring, either by hydraulics or mechanical means. Output can be taken off the last power module. There is a high-speed motor located at the first module. This is used to wind the bands of rubber. There is slip-clutch, which will release when the bands of rubber are totally wound. When the clutch releases, the centrifrugal switch shuts off the winding motor. In the absence of electrical power the energy cell can be manually charged by turning a crank that is connected to a gearbox designed to wind the bands of rubber.

### BRIEF DESCRIPTION OF THE DRAWINGS

FIG. 1 Side elevation of an energy storage cell in accordance with the present invention.

FIG. 2 Side elevation showing eight power modules. This is showing the spacing for the four different modules.

FIG. 3 Side elevation showing the power transfer path. If you follow A down to B then across to C and up to D you can see how these modules are connected in series.

FIG. 4 Side elevation showing the short shaft no spacer band drive assembly.

FIG. 4B Side elevation showing the long shaft and spacer band assembly.

FIG. 4A Side elevation showing one complete power module. The one pictured is the #3 module.

FIG. 5 Side elevation of the band of rubber mounting triangle.

FIG. 5A End elevation of the band of rubber mounting triangle.

FIG. 6 Partial top view of one mounting plate showing standoff mounting holes (19) and bearing mounting holes (20) for the power modules. This view also shows the offset bearing mount hole (20A). Power is going from top left to top right then down and back from bottom right to bottom left.

FIG. 7 Partial top view of the top mounting plate showing the gear locations and the gear overlap.

FIG. 7A Partial top view of the bottom mounting plate showing the gear locations and the gear overlap.

FIG. 8 Top view of the brake and rotor assembly.

FIG. 8A Side elevation of the brake and rotor assembly.

FIG. 9 Side elevation of the high speed winding motor and slip-clutch assembly. This is also showing that the worm drive assembly.

FIG. 9A View of the clutch shaft and the keyway slot.

FIG. 9B Top view of the sliding clutch plate and keyway slot.

FIG. 10 Side elevation of the variable speed govenor.

FIG. 10A Side elevation of the variable speed governor set in the slowest position.

FIG. 10B Side elevation of the variable speed governor Set in the fastest position.

FIG. 11 Top and side view of the follower bar. This bar guides the linkage (57) to follow the slide weights (55)

FIG. 12 Top and side view of the slide weights

FIG. 12A Top and side view of the rod end bearing which connects to the linkage (57) and (60).

FIG. 12B Top and side view of the rod end bearing ball. This ball snaps into the rod end bearing.

FIG. 12C Linkage rod, which connects the slide weight to the sliding hub bearing assembly.

FIG. 13 Top and side view of the pivot arm mounting block.

FIG. 14 Top, side and end view of the pivot arm.

FIG. 15 Top, side and end view of the friction pad and mounting plates.

FIG. 16 Side elevation and top view of the sliding hub bearing assembly.

FIG. 17 Side elevation of the standoff 5A and the bolt (5) that bolts the top plate 7 to the bottom plate 7A.

FIG. 18 Side view of the automatic centrifugal switch which shuts off the winding motor and a wiring diagram of the motor circuit.

FIG. 19 This is a top view of spur gears and shafts in the manual winding gearbox.

FIG. 19A Side view of manual gearbox showing the internal components.

FIG. 19B Top view and side view of the adjustable crank handle for the manual gearbox assembly.

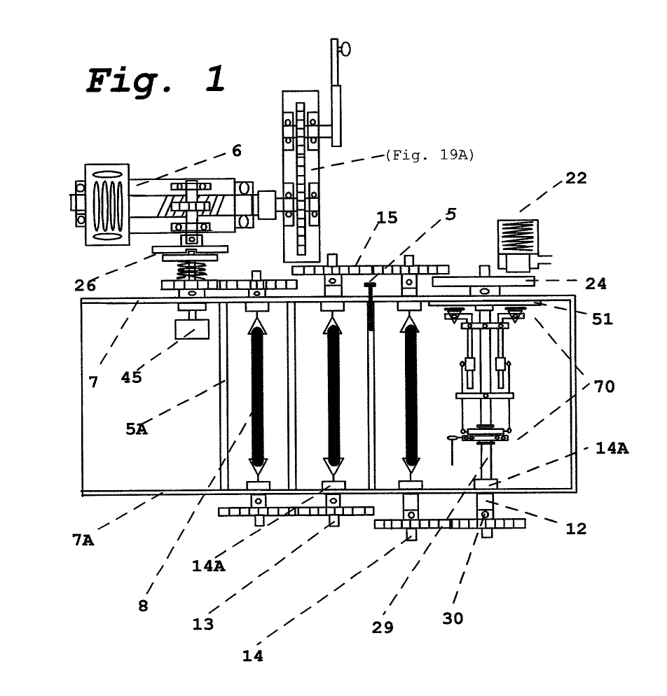

### DETAILED DESCRIPTION

As shown in the drawings the preferred energy storage cell in accordance with the present invention includes a top plate (7) and a bottom plate (7A). The plates are held together and in alignment with standoffs (5A). The plates (7) (7A) are made of aluminum plate the thickness depends on the size of the bands of rubber that are used. The standoffs are aluminum rods threaded at each end. These standoffs are bolted to the plates (7) (7A) by bolts (5). The size and length of the standoffs depend on the size and length of the bands of rubber used.

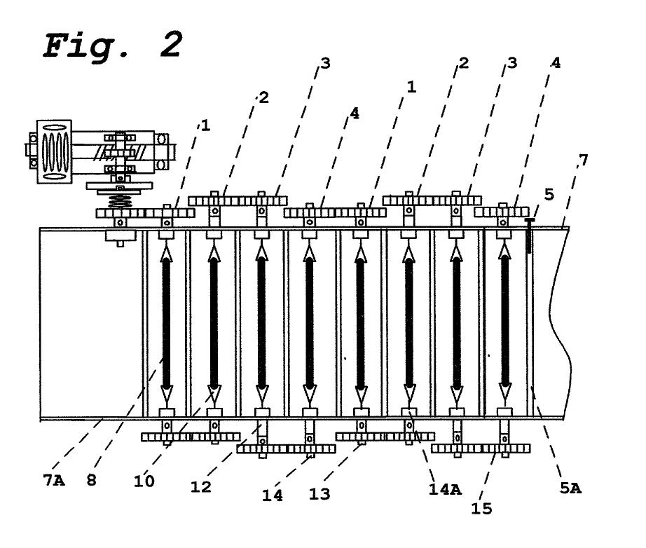

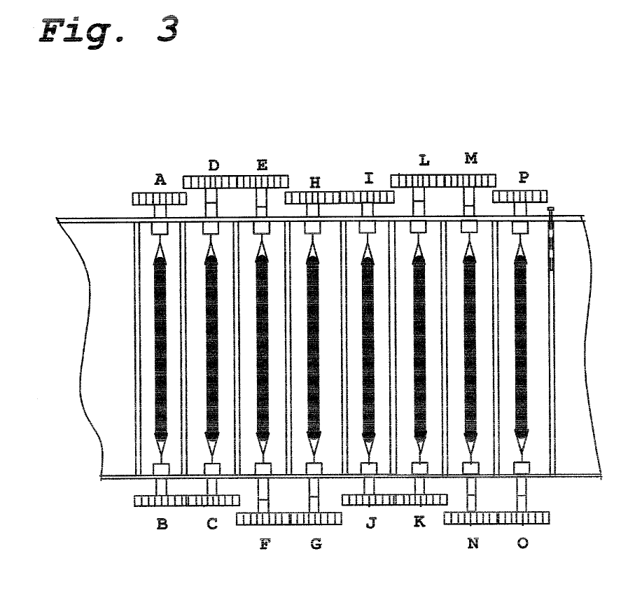

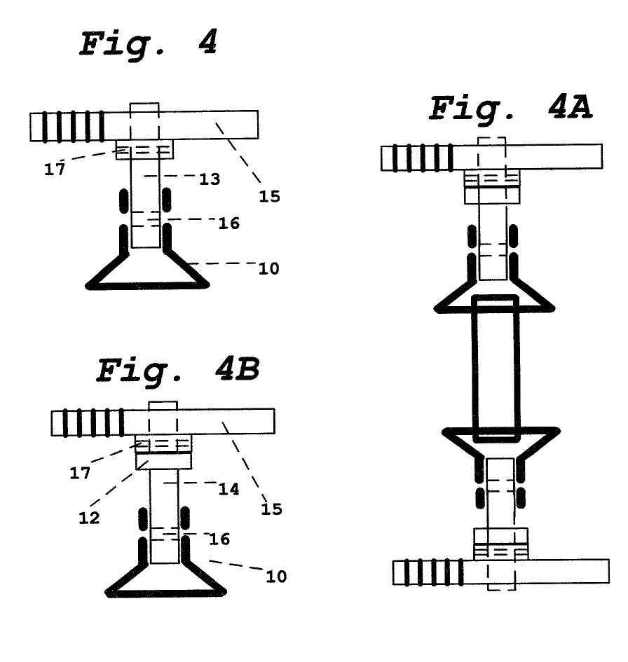

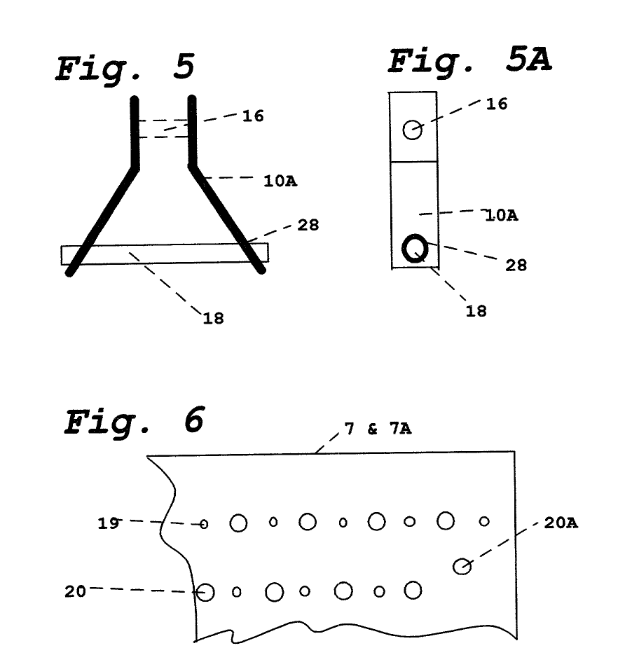

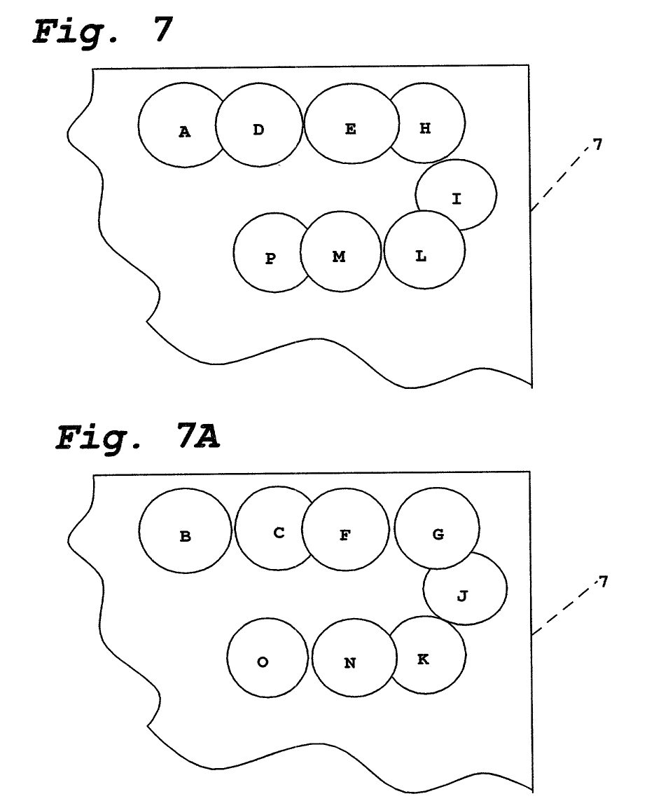

The energy cell can use any number of power modules (FIG. 4A). The power modules consist of one band of rubber, two spur gears (15) bolted to shaft (13) or (14) through hole (17). Two mounting triangle (10) also bolted to shaft (13) or (14) through hole (16). Depending on the power module configuration, spacers (12) may need to be used. The mounting triangle (FIG. 5) is made by bending two steel bars (10A), drilling two holes per bar (16 & 28) and welding a steel shaft (18) to both bars. FIG. 2 shows two groups of power modules. Each group contains power modules one through four, and how the spur gears (15) overlap each other. The overlap is the reason for having two different length shafts (13) (14) and spacers (12). FIG. 3 shows the power modules and how they're connected in series, from A to P.

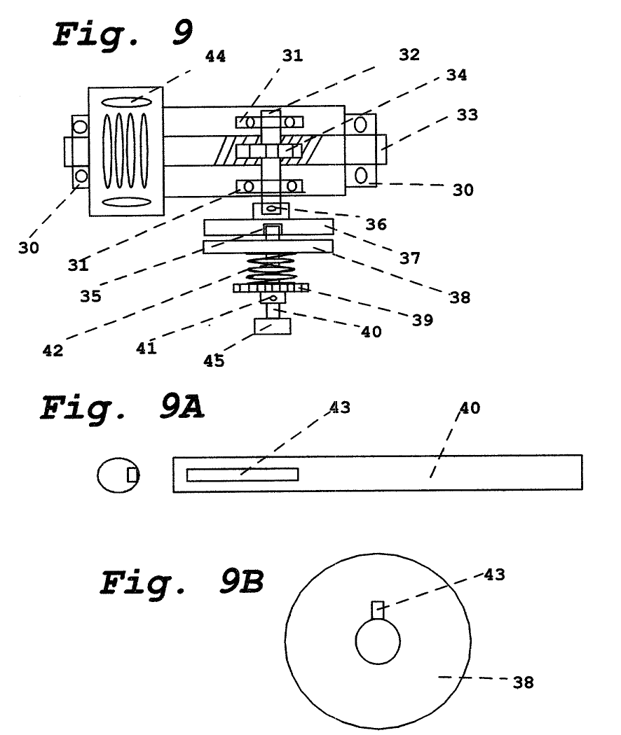

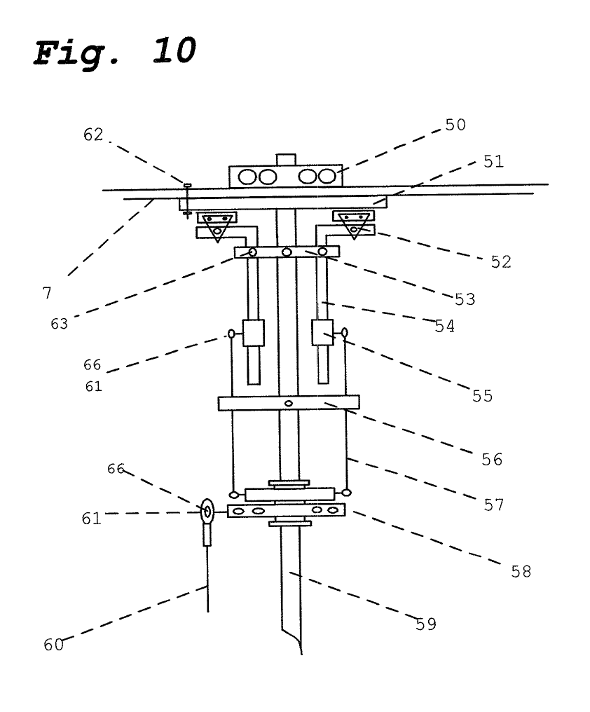

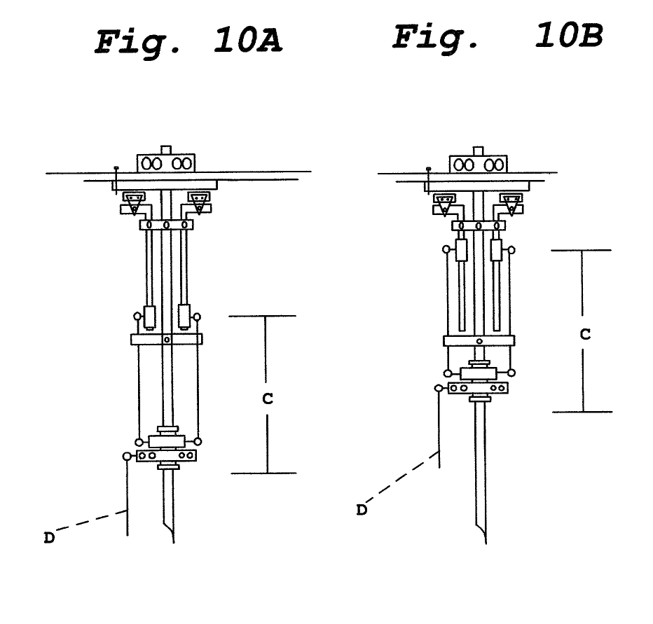

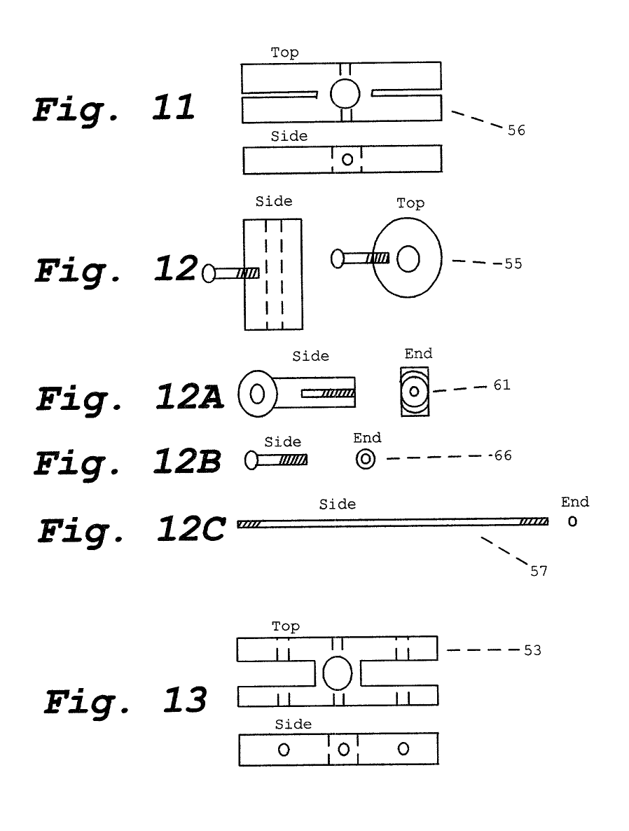

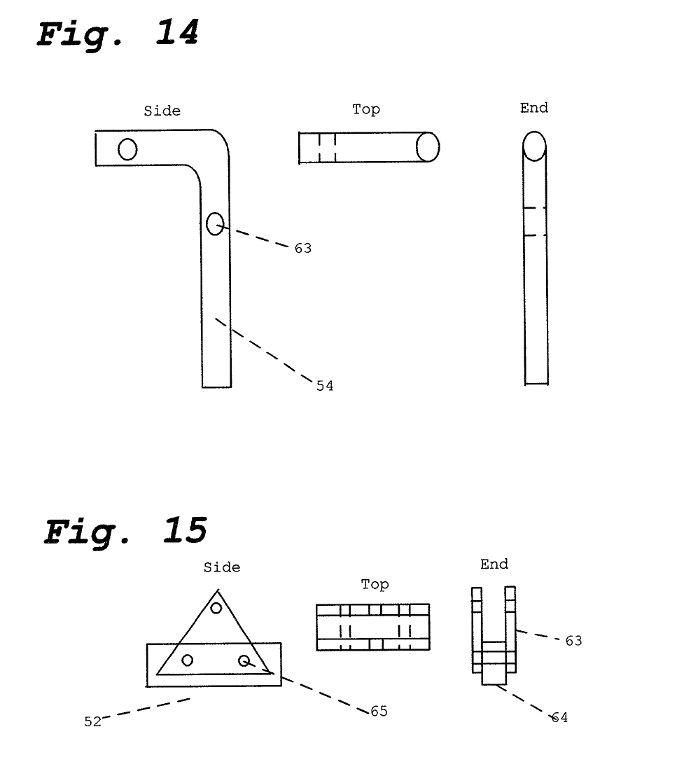

The speed (RPM) of the power cell can be controlled by the centrifugal governor. FIG. 10 shows the variable speed governor. As the governor shaft (59) spins up in RPM, the slide weights (55) are pushed to the outside by centrifugal force. This in turn moves the pivot arm (54) outward, this arm pivots on the pivot pin (63). The friction pad (52) is now pushed against the stationary disc (51) that slows down the RPM. As the RPM slows the slide weights move back in causing less pressure against the stationary disc (51) causing the RPM to increase, therefore maintains a constant speed. The speed at which the energy cell is operating can be controlled by moving the slide weights (55) up and down the pivot arm (54). FIG. 10A shows the slowest setting of the speed governor. By having the slide weight (55) farther from the pivot point (63) leverage causes the friction pad (52) to apply much more force against the friction disc (51). FIG. 10B shows the fastest position of the speed governor. The slide weights (55) being close to the pivot point (63) less leverage causes the friction pad (52) to apply less force against the friction disc (51).

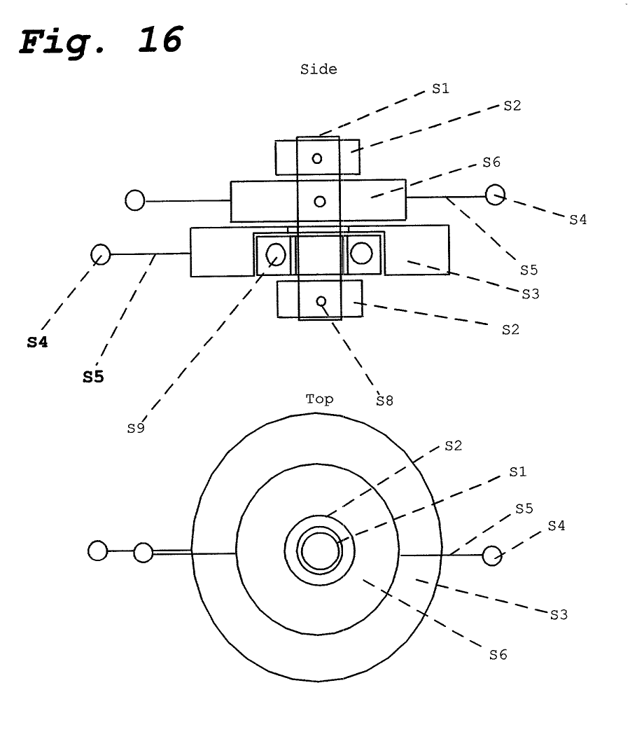

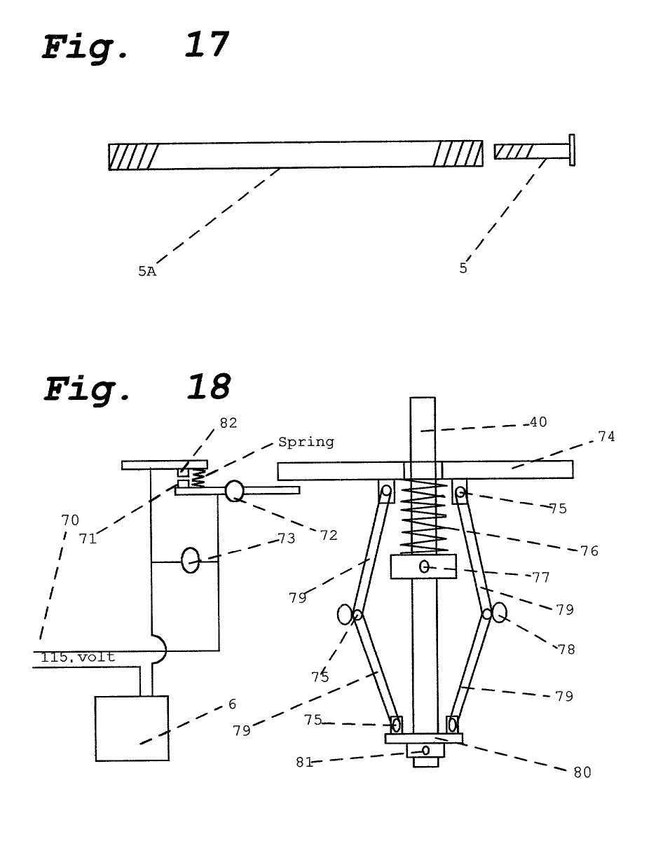

To move the slide weights (55) up and down connected to moving shaft a sliding hub and bearing assembly was needed. FIG. 10 shows the location of the sliding hub assembly (58). FIG. 16 shows the breakdown of the sliding hub and bearing assembly. S1 is the tube that slides up and down the governor shaft (40), it also holds all components of the hub assembly. The shaft colar that hold the assembly together (S2). S3 is a aluminum cup that is bonded to the outside of the slider bearing (S9). This cup also gives a attach point for the rod end bearing ball (S4) and rod (S5). S9 the slider bearing is pressed onto the sliding tube (S1). S6 rotates with the governor assembly and is pulled along by the linkage rods (57) FIG. (10) going through the guide bar (56) FIG. (10). S3 the aluminum cup stays stationary and the bearing (S9) rotates along with (S1,S2,S6). The sliding hub assembly is moved up and down by the linkage rod (60) FIG. 10.

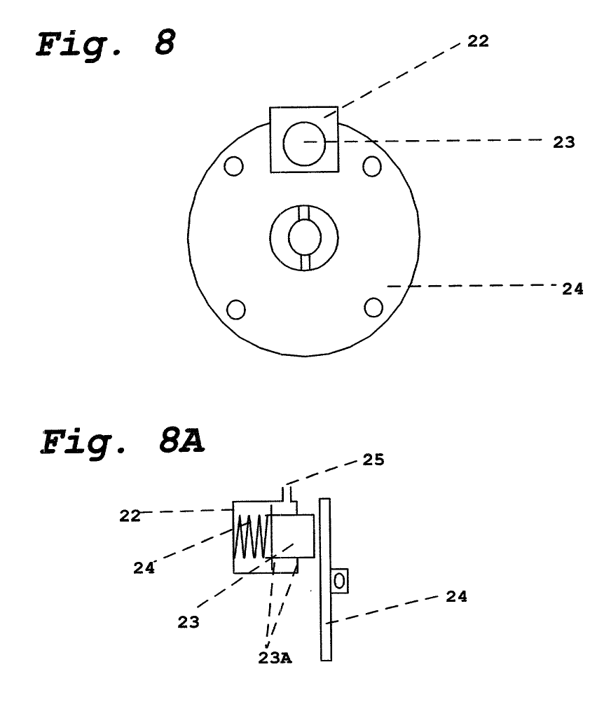

FIG. 8 and FIG. 8A show the brake assembly. The brake assembly (22) can be hydraulic or mechanically activated. The brake is similar to an automotive disc brake except for one major difference: this brake assembly is in the locked position at rest and requires hydraulic or mechanical means to release it. This is done for safety purposes, if the power cell or brake were to fail it would fail in the locked position preventing a runaway situation. FIG. 8 and 8A (22) shows the hydraulic cylinder housing with the fluid inlet (25). The piston and pad assembly has a constant pressure applied to it by an extremely powerful spring (24) that forces the pan against the rotor (24A).

The energy storage cell is recharged with a high speed charging motor (6). When the bands of rubber are completely wound the slip clutch (26) will slip. When the slip clutch slips it causes the centrifugal switch (45) to shut off the charging motor (6). The motor assembly uses a worm gear drive. This type of drive stops the motor assembly from being turned backwards by the output shaft gear. This stops the energy cell from unwinding when the charging motor has stopped charging the energy cell.

FIG. 9 shows the winding motor breakdown. (44) is the motor windings. (33) is the worm gear and armature assembly. (32) is the drive shaft, which is attached to the drive gear (34) and the slipping clutch drive disk and lining (37) by set screw (36). The secondary clutch disc, this disc (38) can slide up and down the lower drive shaft (40) Disc (38) is keyed to drive shaft (40), the key is located in slot (43) of the shaft (40) and the secondary disc (38). This key stops any slippage between the shaft and the disc (38) but still allows the disc (38) to slide up and down the shaft (40). The motor output drive gear (39) is attached to the shaft (40) by a setscrew (41). The spring (42) applies the correct amount of pressure on the slip clutch to cause it to slip when the bands of rubber are wound to there maximum. This system is used to stop over winding and possible damage to the cell. The auto shut off centrifugal switch (45) is located on shaft (40).

The auto shut off winding governor (45) can be seen in FIG. 18. The governor is driven off drive shaft (40). The drive shaft spins the drive block (80), which is attached to the shaft (40) by setscrew (81). The weights (78) are mounted to the pivot arms (79) the pivot arms pivot on the pins (75). As the RPM increases the weights (78) are moved outward due to centrifugal force. This outward movement brings the switch activation plate (74) down to close switch (71). As seen by the red wiring diagram, power is supplied at (70). The power is connected to the high speed winding motor (6) also shown in FIG. (9) and the other to one contact point (71). The other motor wire is connected to the other contact point (82). The motor start switch (73) is wired across the points in parallel. The push to start switch (73) is a momentary on switch, by holding the switch until the motor is up to speed, and the centrifugal switch assembly takes over and keeps contact 82 and 71 closed. When the slip clutch (26) starts slipping this causes the centrifugal switch contacts 82 and 71 to open which shuts off the winding motor.

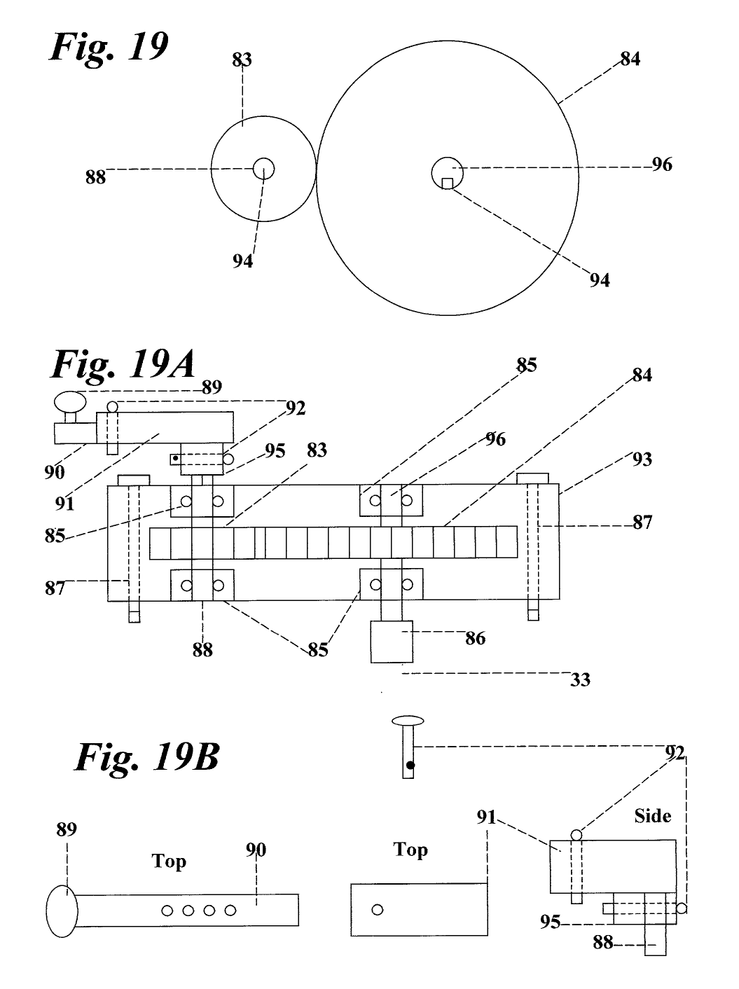

FIG. 19A shows the Power Transfer Gearbox. This gearbox is designed to transfer power from a crank driven gear through a larger gear (or gears) to increase the torque applied to the winding shaft (FIG. 9 #33). This is done so the operator is able to charge the cell with as little effort as possible. Shown in FIG. 19 are two gears (83,84) that are keyed (94) to the center shafts (88,96) that turns in roller bearings (85). These gears represent a 3:1 ratio. This gear ratio can be changed and gears may be added as per the size of the energy cell. The gearbox case FIG. 19A (93) is made of aluminum plate. The thickness of the plate depends on the size of the cell it is mounted on. It is mounted to the cell with two to four bolts (87) depending on the size of the cell it's mounted on. The charging crank FIGS. 19A&B (89,90,91) is adjustable in length to give the operator more leverage when space permits. The crank is made in three pieces, the knob (89), the stationary receiver (91), and the sliding portion (90). The sliding portion has holes in it that represent different lengths it can be extended to. The sliding portion (90) is fastened to the stationary receiver with a ball snap pin (92). This same type of pin attaches the splined shaft (88) to the splined receiver (95) on the bottom side of the stationary handle receiver (91). The connection to the power cell is made through a splined cop FIG. 19A(86) on the end of the large gear output shaft (96) that sits over the splined winding shaft (33).

I claim:

1. The energy storage cell can store a large amount of energy in a small area. This is done by using bands of rubber geared together in series. This enables you to put hundreds of feet of rubber in a very small area.
Example: Our prototype lawn mower uses a 12″ by 12″ frame that is 13 inches high. The bands of rubber are 1″ wide and 12″ long. The bands of rubber mounting triangles are located 1¼″ center to center apart. 81 bands of rubber fit into the 12″ by 12″ frame. Each band of rubber runs the mower blade for 15 seconds. 15×81=1215 seconds or 20.25 minutes. For a longer run time a 15″ by 15″ cell will hold 121 bands of rubber. Each band of rubber runs the blade for 15 seconds. 15×121=1815 seconds or 30.25 minutes.

2. The energy storage cell can be built in many different power and size configurations. Such as the sizes of the bands of rubber, length, width and thickness. Also the number of power modules used.

3. The energy storage cell can power hundreds of different items with no direct pollution.

4. Power output (RPM) is controlled smoothly by a variable speed governor. This type of speed control waists very little energy.

5. This power cell can be charged quickly and automatically by a high-speed worm drive winding motor that shuts off when the cell is fully wound. The worm drive also stops the power cell from unwinding, when the winding motor is off.

6. In the absence of electrical power this power cell can be manually Charged with an operator-powered crank connected to transfer gearbox.
